(19) United States
(12) Patent Application Publication
(10) Pub. No.: US 2008/0211655 A1
(43) Pub. Date: Sep. 4, 2008

(54) Courtesylite

(76) Inventors: W. Eugene Trefren, Tacoma, WA (US); Chad Michael Towns, Tumwater, WA (US)

Correspondence Address: W. EUGENE TREFREN, 12003 PARK AVE, TACOMA, WA, 98444, US

(21) Appl. No.: 11/594,459

(22) Filed: Nov. 9, 2006

(51) Int. Cl. B60Q 1/26

(52) U.S. Cl. 340/468

(57) ABSTRACT

A signaling assembly for the conveyance of thoughts (as opposed to actions) from one driver to another which include a signaling device and a remote activation switch/button. The signaling device which as a whole is moisture impervious includes a lens, casing, light source, and reflective element, is designed to create a cone like light pattern that is violet in hue and radiates away from the vehicle which signaling assembly is affixed (the apex of cone originating form aforementioned light source). Furthermore, the light pattern is violet in hue so as to be distinguishable from other signaling colors already in use. The remote activation switch can be either a radio frequency setup or a conventional by-wire setup, the latter being more preferable if the invention is installed at the vehicle manufacturing stage and the former being more preferable if the invention is installed as an aftermarket product.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

This invention generally relates to a lighting system more particularly a remotely actuated lighting system to communicate Modern Western etiquette in roadway settings. Said invention is particularly adapted to affix to the exterior body of a vehicle, but may also be mounted in the interior of a vehicle for use of the same said purpose.

Non-communication particularly between two or more drivers can facilitate hazardous roadway environments, which is of particular concern in metropolitan areas. Communicating via the use of vehicle turn signals and brake lights, when used for respective intended purposes, only allows a driver to communicate what he or she intendeds to do or is in the process of doing with his or her vehicle.

Accordingly, a need exists for a lighting system to communicate what the vehicle operator is thinking in terms of Modern Western etiquette in roadway settings; such as saying an appropriate hi or a more appropriate thank you or sorry, depending on the situation at hand. Any such system would need to be aesthetically pleasing, ergonomically designed and not burdensome in use.
Current U.S Class: 340/468; 40/588; 362/496; 362/485; 362/505; 362/503
Current International Class: B60Q 1/50 (20060101); B60Q 1/26 (20060101)
Field of Search: 340/468, 477, 468, 500, 362/459, 812, 40/590, 591

### REFERENCES CITED

### U.S Patent Documents

| | | |
|---|---|---|
| 5,119,278 | Jun. 2, 1992 | Watson |
| 5,574,428 | Nov. 12, 1996 | Groover |

### Foreign Patent Documents

| | | |
|---|---|---|
| 748,297 | December, 1966 | CA |
| 1,091,885 | September, 1954 | DE |
| 1,528,591 | October, 1978 | GB |

### Other Publications

Texas Instruments, Linear Circuits Data Book 1984 (Op Amps, Comparators, Timers, Regulators, a/D Peripherals) Austin, Tex. USA

### BRIEF SUMMARY OF THE INVENTION

The invention provides vehicle drivers a pragmatic way to communicate Modern-Western-etiquette related gestures such as saying an appropriate hi to a friend or congratulations to a fan of a commonly liked sports team (after the big win for example) or a more appropriate thank you when a vehicle operator lets another vehicle operator into a busy lane or sorry when one driver accidentally cuts-off another driver, for example.

Although Modern Western etiquette is not strictly defined, the invention facilitates via symbolic representation well known Modern-Western communiqué as described above. Furthermore, by facilitating this type of communication especially within metropolitan areas within predominately Western societies, the invention not only promotes emotional wellbeing, but also lessens the possibility of a misunderstanding between two vehicle drivers, which at times can led to unsafe conditions for all persons utilizing a roadway and its surrounding area.

To accomplish communiqué, operator of vehicle in which invention is affixed activates a remote push button located preferably on vehicle steering wheel and more preferably proximate a touching area of said operator, while his or her hand is still affixed to outer circular portion of said steering wheel. Once pushed, the remote push button preferably completes electrical circuit of invention; thus, ultimately activating light source found within signaling device preferably located to the immediate right of the left exterior tail light or elsewhere as appropriate. In an alternative embodiment, remote push button utilizes a radio frequency transmitter and signaling device utilizes a receiver of the same sort thus eliminating the need for additional, aftermarket wiring within the vehicle.

Once circuit is complete, duration of transmission of electrical current to signal light is regulated by timing device (such as a 555 timing chip). Preferably the timed duration is such that the light source preferably illuminates for more than 2 seconds and less than 30 seconds and more preferably around 10 to 15 seconds. Once light source receives predetermined duration of electrical current, light source emits pattern of violet colored light that is preferably provided by a violet light source. Alternatively, violet colored light can be provided by a filtering lens. The generated pattern of violet light is discernable to driver immediately behind vehicle which invention is affixed, but largely imperceptible to driver of vehicle which invention is affixed.

Advantageously, the signal light, providing communication function from one driver to another, is provided as a module that is suitable for use on the interior or exterior of various vehicles. The signaling device—which includes an enclosure, a light-transmitting opening, a light source in the enclosure, a power source, and a timing device in the enclosure—is capable of low cost, easy manufacture, and compactness. Enclosure is preferably a unitary assembly with lens covering the light-transmitting opening permanently joined with the remainder of the enclosure.

### BRIEF DESCRIPTION OF THE SEVERAL VIEWS OF THE DRAWING

The foregoing and other objects, advantages, purposes, and features of the invention will be more apparent with reference to the following descriptions as illustrated by the drawings, in which:

FIG. 1 is a top view of the present invention;

FIG. 2 is a breakaway perspective view of FIG. 3 revealing internal components thereof;

FIG. 3 is a front view of the present invention;

FIG. 4 is a breakaway perspective view of FIG. 5 revealing internal components thereof;

FIG. 5 is a back view of vehicle having the signal light of the present invention;

FIG. 6 is a back view of vehicle having the signal light of the present invention;

FIG. 7 is a back view of steering wheel having the remote transmitter of the present invention;

FIG. 8A is a top view of a vehicle having the signal light and remote transmitter/switch of the present invention when as is preferable embodied as a product to be installed during the manufacturing of vehicle;

FIG. 8B is a schematic view of the electrical circuit of present invention when as is preferable embodied as a product installed during the manufacturing of vehicle;

FIG. 9A is a top view of a vehicle having the signal light and remote transmitter of the present invention when embodied as an aftermarket product;

FIG. 9B is a schematic view of the electrical circuit of present invention when embodied as an aftermarket product;

FIG. 11 is a plain view of present invention illustrating related produced light pattern;

FIG. 12 is a top view of the present invention illustrating related produced light pattern;

FIG. 13 is an illustrative view of the present invention in use; and

FIG. 14 is an illustrative view of the present invention in use

List of reference numbers: with regard to reference numbers used, the following numbering is used throughout the drawings.

| | |
|---|---|
| 50 | Signaling device |
| 52 | Lens |
| 54 | Casing |
| 56 | Light source |
| 58 | Reflective element |
| 60 | Optical surface |
| 62 | Break light/signal light |
| 64 | Rear windshield |
| 66 | Left side |
| 68 | Rear hatch/tail gate |
| 70 | Remote actuator |
| 72 | Remote switch/button |
| 74 | Steering wheel |
| 76 | Steering wheel support arm |
| 78 | Signaling device circuit |
| 80 | Wire |
| 82 | Timing circuit |
| 84 | Ground |
| 86 | Battery |
| 88 | Radio frequency coupled receiver |
| 90 | Light pattern |
| 92 | Vehicle driver |
| 94 | Another vehicle driver |

### DETAILED DESCRIPTION OF THE INVENTION

The following discussion describes in detail one embodiment of the invention. This discussion should not be construed, however, as limiting the invention to those particular embodiments since practitioners skilled in the art will recognize numerous other embodiments as well. For a definition of the complete scope of the invention, the reader is directed to the appended claims.

Although Modern-Western etiquette is not strictly defined, herein described device facilitates via symbolic representation well known Modern-Western communiqué; such as, saying an appropriate thank you or sorry. Furthermore, by facilitating this type of communication especially within metropolitan areas within predominately Western-thinking societies, the invention not only promotes emotional well-being, but also lessens the possibility of a misunderstanding between two vehicle drivers; these miscommunications at times advance unsafe conditions for all persons utilizing a roadway and its surrounding area.

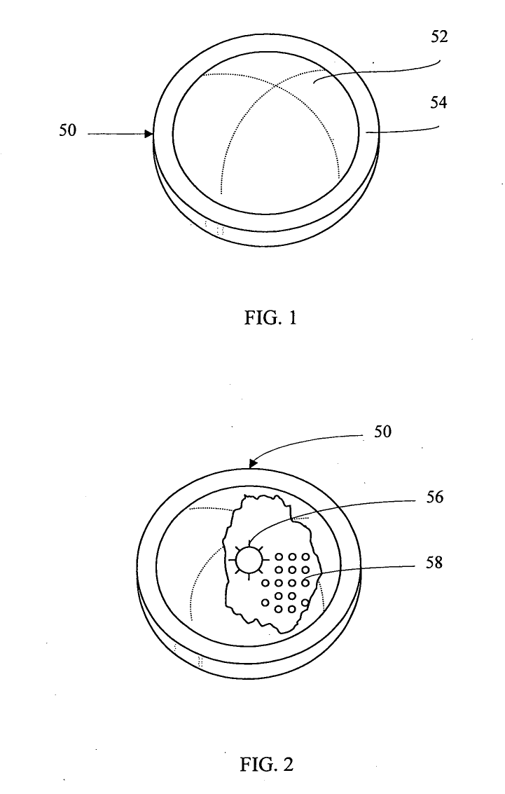

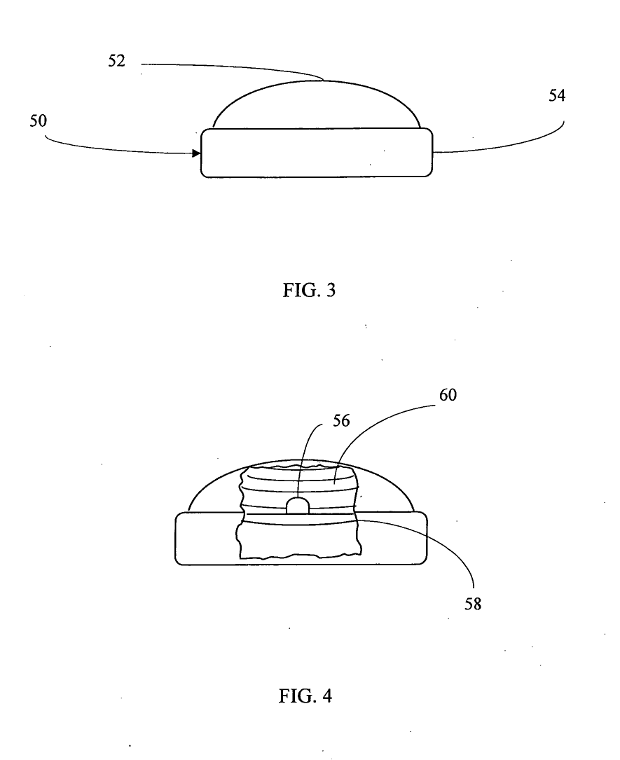

In reference to FIGS. 1 and 3, lens 52 is preferably made of a durable plastic such as acrylic and formed in such a way so as to enhance light source 56 over which lens 52 is placed; for example, a concave shape lens with a sinusoidal non-opaque optical surface 60 would work well for this purpose. Examples of a lens with a sinusoidal surface would include, but would not be limited to, a segmented lens, a prismatic lens, and a Fresnel lens. Furthermore, a lens 52 made of a polycarbonate or glass material and formed in a planar shape with a clear optical surface 60 or the like would also be suitable for this purpose.

In relation to casing 54, it is preferably made from an opaque substantially heat-resistant material that is cup-shaped and includes means to support a reflective element 58 (as described below). Casing 54 is preferably injection-molded from a suitable plastic such as a polymer material which preferably has a heat distortion temperature (as measured by ASTM S 506 for a 92.7.times.92.7 times.6.4 mm specimen and at 6070 kPa) of at least approximately 72.degree. C., more preferably at least approximately 906.degree. C., and most preferably at least approximately 570.degree. C. In the illustrated embodiment, casing 54 is fabricated of heat-resistant polycarbonate. Alternatively a mineral-filled or glass-filled nylon, a polyester or acrylonitrile butadiene styrene (ABS) polymer, or a thermoplastic or thermoset material would also be suitable materials for casing 54.

So as to make signaling device 50 substantially moisture impervious, lens 52′ and casing 54 are preferably fitted together by suitable means such as conventional sonic welding, vibration welding, or by the use of suitable adhesives.

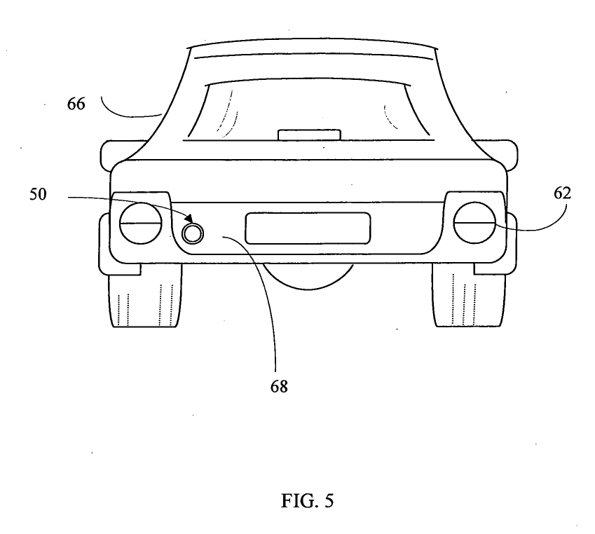

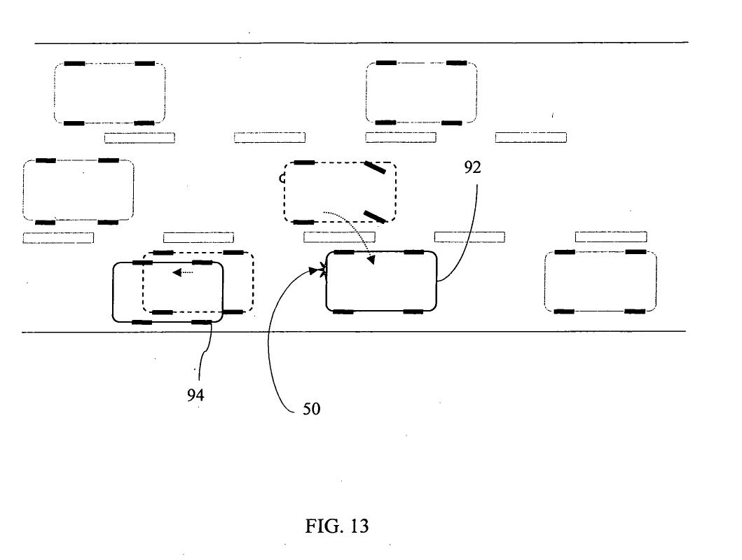

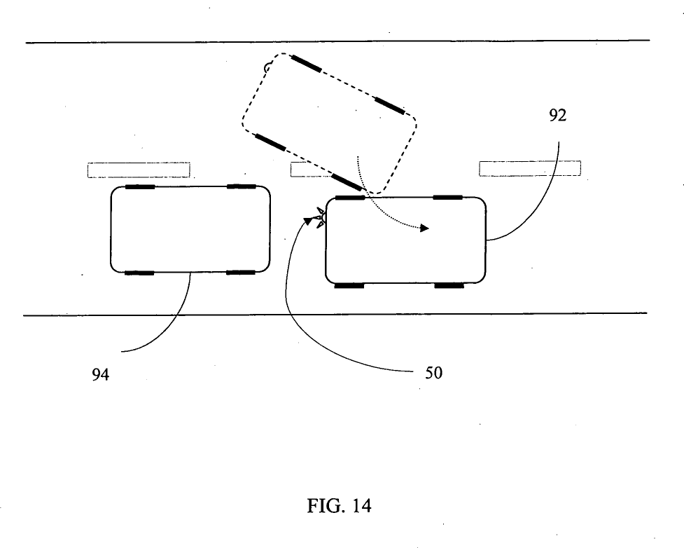

As seen in FIGS. 2 and 4, signaling device 50 includes a reflector 58 directly behind light source 56. Reflector 58 is to direct the light from light source 56 into the preferred light pattern 90 illustrated in FIGS. 92 and 13. Reflector 58 utilizes a suitable reflective surface such as vacuum metalized plastic; alternatively, reflector 58 can consist of any other suitable reflective surface such as a metal reflector (such as a stamped aluminum reflector, a polished metal reflector), a painted/coated printed surface with a high specular and/or diffused paint, film, tape, coating, or the like, a vacuum metalized substrate (such as vacuum metalized glass, a metalized or reflective mineral filled substrate, such as a mineral filled plastic substrate) a reflective metal filled substrate (such as a metal filled plastic) or the like. In addition, reflector 58 is preferably a separate member, from the light source 56; yet, light source 56 and reflector 58 may alternatively be provided as an assembly.

In relation to light source 56, the preferred method utilizes a solid state source such as light emitting diode (LED) that preferably emit a blue-violet, violet, or red-violet illumination without the need for ancillary filters. A LED such as LED lamp T1 3/4 (5 mm) UVA-L50ACA utilizing InGaN, commercially available from Uniroyal Optoelectronics, under the designation T1 3/4 (5 mm) UVA-L50ACA would be suitable for this purpose. Alternatively a LED utilizing dual-bond construction technology, such as LED Light LED-Can type (5 mm) E1L5M-3P0C2-01, commercially available from Toyoda Gosei, under the designation LED-Can type (5 mm) E1L5M-4P0C2-01, E1L5M-3P0C2-01 could be used to achieve preferred illumination color within stated parameter.

Alternatively, while a solid state light source 56 is preferred, a variety of non-electromechanical and electromechanical illumination devices may also be use such as an incandescent light source (such as a conventional incandescent fuse lamp) a fluorescent light source (such as a cold cathode fluorescent light) a phosphorous lamp, a halogen lamp, a neon light, a discharge lamp, an arc lamp, an electro-luminescent light (including inorganic or organic electro-luminescent sources) or a laser diode.

Nevertheless, the illumination color of light source 56 is preferably blue-violet, violet, or red-violet, so as not to cause confusion with other signals/communiqué. For example, red indicative of a vehicle slowing down; white indicative of vehicle backing-up; and yellow indicative of vehicle turning or moving slowly. In addition, blue is not preferable because it can be easily associated light signals used by police officers and green is also not preferable because it may trigger a subconscious urge to go (step on the gas pedal), which may indirectly result in a traffic accident. In essence, violet is the preferable color because of its, as of yet, non-use in relation to motor vehicles, aside from decorative purposes.

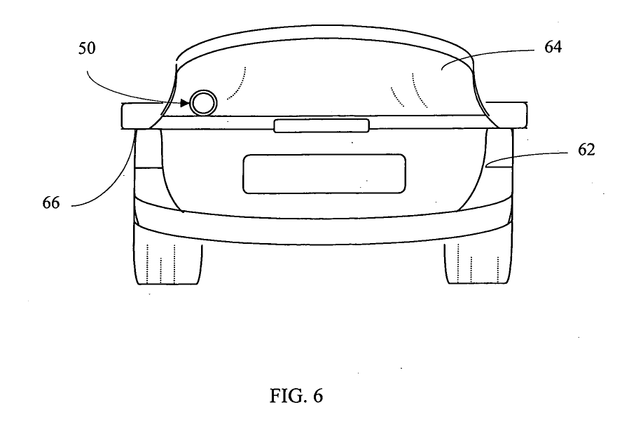

As illustrated in FIG. 5, signaling device 50 is preferably located to the immediate right of the left 66 exterior tail light 62. Alternatively, other locations are possible for signaling device 50, including the interior or exterior left side 66 portion of the rear windshield 64 as seen in FIG. 6, the exterior portion of the rear hatch/gate 68, or elsewhere on the vehicle body as appropriate. It is preferred that signaling device 50 be located on the left side of the vehicle so as to (1) have some level of conformity of placement and (2) increase identifiability of invention and related purposes and (3) facilitate related network effect.

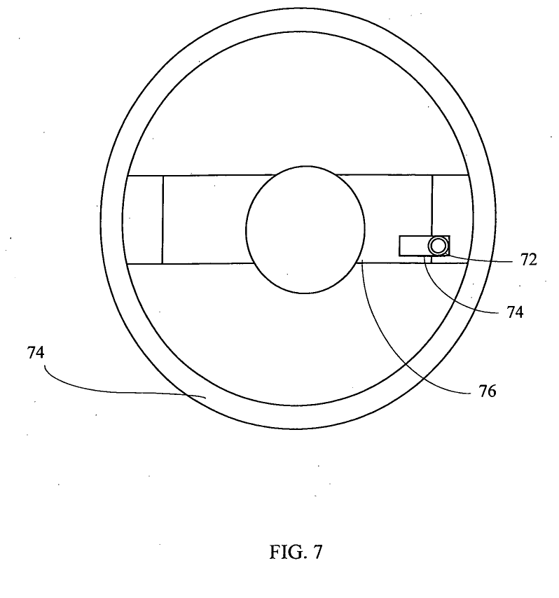

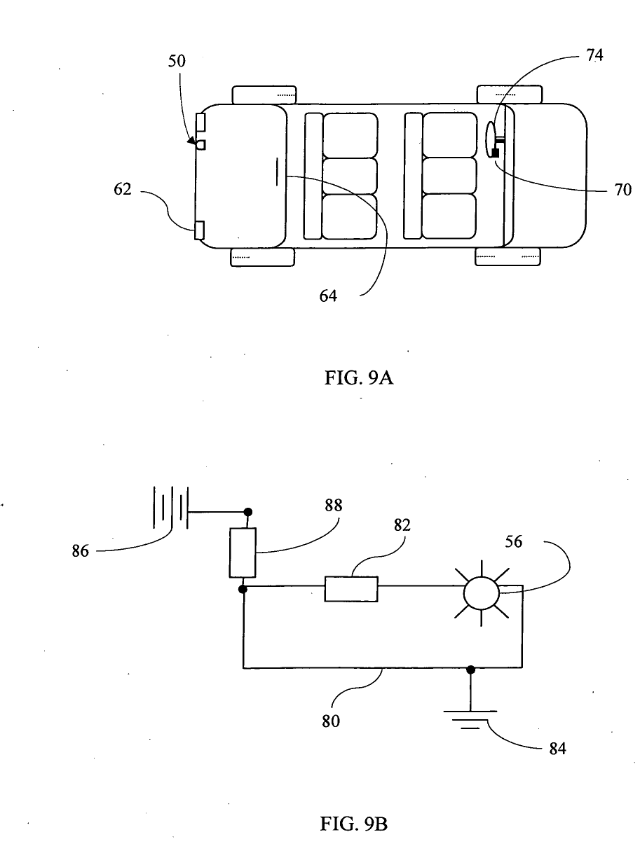

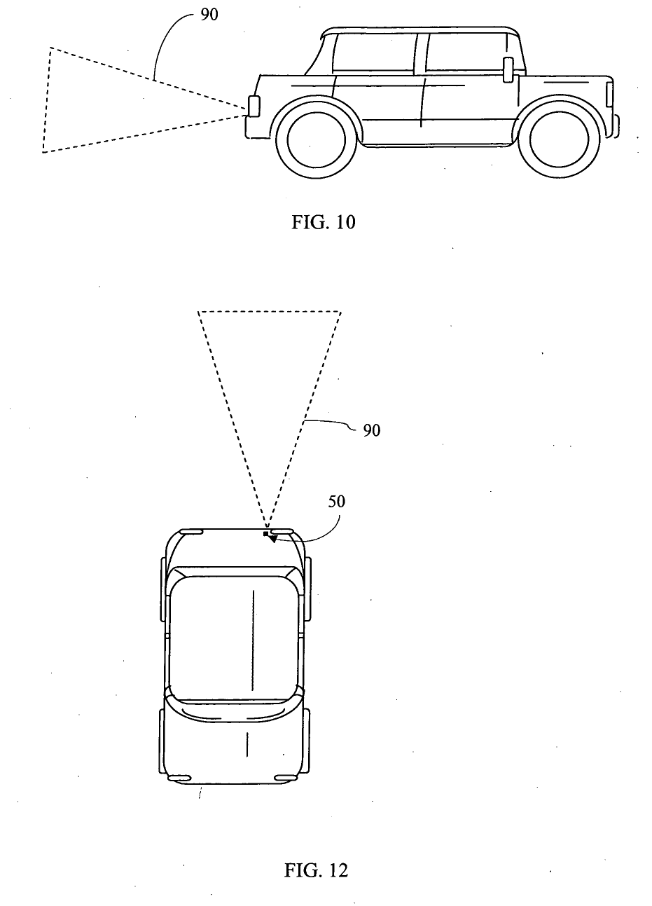

In reference to FIG. 7, remote actuator 70 includes a remote switch/button 72 for the purpose of completing signaling device circuit 78 (FIG. 9). In addition, remote actuator 70 is preferably affixed to vehicle-steering-wheel 74 supporting arm 76 and more preferably affixed so that the driver need only reach out a finger (without releasing his or her grip on steering wheel 74) in order to utilize invention.

Remote actuator 70 preferably utilizes conventional electrical wire 80 to supply signaling device 50 with electrical power from electrical source such as the car battery 86 when signaling device circuit 78 is completed.

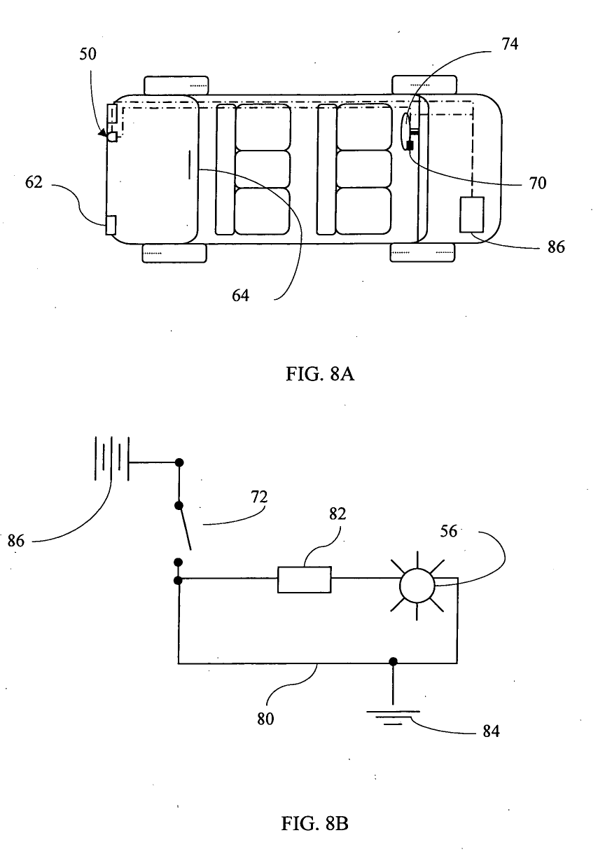

FIGS. 8 and 9 are the preferable embodiment of invention particularly if invention is installed during vehicle manufacturing stage. If installed at that stage, signaling device 50 and remote actuator 70 could utilize car battery 86 and wire 80 could be bundled along with other power or communication lines already incorporated into the vehicle.

Alternatively, remote activation of signaling device 50 could be accomplished using radio waves or the like due to the ability of radio waves to go through possible barriers between remote actuator 70 and radio frequency coupled receiver 88 (FIG. 11), barriers such as a driver's shoulder, seat cushions, passengers, and the rear window 64, for example.

In reference to FIGS. 50 and 11, signaling device 50 is remotely activated by radio signal transmitted from remote actuator 70. In addition, although (1) both signaling device 50 and remote actuator 70 would possibly requiring dedicated batteries respectively and (2) remote switch/button 72 (FIG. 9) would need to be replaced with a radio frequency coupled receiver 88 (FIG. 50), additional, aftermarket wiring within the vehicle (FIG. 8) would not be needed.

In reference to FIGS. 9 and 11, the timing of light source 56 is preferably regulated by a timing circuit 82 such as a 555 timer chip. A 555 timer chip is typically packaged as an individual timer on an eight-pin DIP. Statistics for this chip can be found in the Linear Circuit Data Book, “OpAmps, Comparators, Timers, Regulators, A/D Peripherals” by Texas Instruments Incorporated. A 555 timer chip is wired substantially by providing appropriate capacitors and resistors to pins 1-8 as is conventional. Pin numbering as used herein corresponds to conventional nomenclature utilized, for example, in the Linear Circuit Data Book. Specifically, pin 1 is “Ground”; pin 2 is “Trigger”; pin 3 is “Out”; pin 4 is “Rest”; pin 5 is “Control”; pin 6 is “Threshold”; pin 7 is “Discharge”, and pin 8 is “V.sub.CC”. Hence, remote actuator 70 is connected between ground 84 and the respective timer's trigger (pin 2). When remote switch/button 72 is depressed, the respective timer trigger goes low and the timer is started, causing an “out” signal to generate at its pin 3. This “out” signal lasts for the duration of the timer's cycle and serves to control a relay that serves to close the signaling device circuit 78.

Note that a pull up resistor pulls “Rest” pin 4 into a “high” state during normal operation.

Alternatively, timing of light source 56 can be implemented in a software-based system or by other forms of control circuitry.

Having described the parts of the invention, a description of the operation(s) of those parts will now follow.

As depicted in FIGS. 10 and 12, light source 56 reradiates at 45.degrees. or thereabouts, operates with a forward voltage of about 2 to 9 volts, and emits with a dominant wave length of about 370 nm to about 435 nm.

It is understood that since violet light is a mixture of red and blue/violet, no color mixture perceived as violet in hue can be assigned a proper dominant wavelength.

In addition, in operation light source 56 preferably produces a light intensity within the range of about 0.3 to about 700 candela, more preferably, in a range of about 0.6 to about 150 candela, and most preferably, in a range of about 1.0 candela to about 56 candela, such that light source 56 preferably meets the specification for applicable automobile industry standards.

FIG. 94 and FIG. 15, shown herein, are illustrative views of the present invention in use. The invention provides vehicle driver 92 a pragmatic way to communicate Modern-Western-etiquette related gestures such as saying an appropriate hi to a friend or congratulations to a fan of a commonly liked sports team (after the big win for example) or a more appropriate thank you when a vehicle 92 driver lets another driver 94 into a busy lane as illustrated in FIG. 94 or sorry when one vehicle driver 92 accidentally cuts-off another vehicle driver 94 as depicted in FIG. 15.

In operation the driver preferably need only reach out his or her finger without releasing grip on steering wheel 74 in order to activate the remote switch/button 72, complete signaling device circuit 78, and maintain an optimal control of vehicle. Once said circuit is complete, duration of electrical current to signal light 56 from power source 86 is regulated by timing circuit 82. Preferably the timed duration is such that the light source 56 illuminates for more than 2 seconds and less than 30 seconds and even more preferably between 10 to 15 seconds. Once light source 56 begins to receive predetermined duration of electrical current, light source 56 preferably emits light pattern 90 of aforementioned violet-color. Generated light pattern 90 is discernable to driver immediately behind vehicle of upon which invention is affixed, but largely imperceptible to driver of vehicle of which invention is affixed.

The foregoing has been a detailed description of a preferred embodiment. Various modifications and additions can be made without departing from the spirit and scope of the invention. For one example, timing circuit and overall system circuitry can also be implemented using analog circuitry or microprocessors having software control. For another example, signaling device 50 and lens 52 can also take on many shapes such as circular, oval, trapezoidal, triangular, etc.

This description, therefore, is meant to be taken only by way of example and not to otherwise limit the scope of the invention. The scope of the invention should be determined by the appended claims and their legal equivalents.

Embodiments of invention in which exclusive property rights or privileges are claimed are defined as follows:

1. A signaling device comprising:
(a) signaling means for communicating a plurality of thoughts from one person to another wherein said signaling means is generally utilized in a roadway setting

2. The signaling device as claimed in claim 1 wherein said signaling means is generally utilized to communicate a plurality of thoughts selected from the group consisting of courtesies and etiquettes whereby possibly thwarting escalated tension between aforementioned drivers.

3. The plurality of thoughts selected from the group consisting of courtesies and etiquettes as claimed in claim 2 wherein said group is characteristic of Modern Western norms and values as is conventional.

4. The signaling device as claimed in claim 1 wherein means for communicating a plurality of thoughts comprises:
(a) a signal device
(b) remote button/switch.

5. The signaling device as claimed in claim 4 wherein said signaling device further includes:
(a) means for automatically deactivating said signaling device after a predetermined amount of time whereby said means for automatically deactivating said signaling device makes-ready said signaling device to be used again.

6. The signaling device as claimed in claim 4 wherein said signal device comprises means for the production of light whereby said means for the production of light is arranged to roughly produce of said light, a conical shaped light pattern that radiates outward and away from vehicle in which said signaling device is affixed.

7. The light as claimed in claim 6 wherein said light pattern generally has a dominant wave length of about 395 nm to about 504 nm.

8. The signaling device as claimed in claim 6 wherein said means for the production of light comprises:
(a) a light source capable of producing an luminous intensity of about 0.3 candela to about 700 candela
(b) a lens of adequate size and appropriate shape so as to generally cover said light source as is conventional
(c) power source sufficient enough to power said signaling device
(d) reflective element to direct light of said light source as is conventional.

9. The signal device as claimed in claim 8 wherein said lens comprises at least one of a sinusoidal lens, segmented lens, a prismatic lens and a Fresnel lens whereby said lens helps to optimize said light from said light source.

10. The signaling device as claimed in claim 8 wherein said optical lens is generally non-opaque.

11. The signaling device as claimed in claim 8 wherein said reflective element is generally parabolic in shape when viewed horizontally.

12. The signaling device as claimed in claim 2 wherein said remote button/switch comprises:
(a) means for controlling signal device wherein said means for controlling signal device is generally located within a reaching area of a vehicle driver whereby said driver can easily reach and thus utilize said means for controlling signal device.

13. The remote button/switch in claim 12 wherein said means for controlling signal device is located within a touching area of said vehicle driver whereby said vehicle driver would need only move a finger while the rest of said driver's hand remains on the steering wheel to utilize said means for controlling signal device whereby said driver while utilizing said means for controlling signal device retains an optimum control of said vehicle

14. The remote button/switch in claim 12 wherein said means comprises:
(a) an electrical device selected from the group consisting of electrical buttons and electrical switches.

15. A method of communicating a thought from one motor vehicle driver to another comprising:
(a) activating a signaling device using a remote button/switch whereby said method of communicating helps to limit the proverbial drawing of assumptions between the vehicle drivers.

16. The method of communicating as claimed in claim 15, wherein said thought is selected from the group consisting of courtesies and etiquettes whereby facilitating courtesy and etiquette in roadway settings and thus facilitating roadway safety via limiting the said proverbial drawing of assumption between vehicle drivers.

17. The method of communicating as claimed in claim 15, further comprising canceling after a predetermined amount of time said signaling device after said signaling device has been asserted by a driver
